(19) United States
(12) Patent Application Publication
(10) Pub. No.: US 2009/0027298 A1
(43) Pub. Date: Jan. 29, 2009

(54) Antenna Radome With Integrated Director Element

(75) Inventors: Mark DURON, East Patchogue, NY (US); Richard T. Knadle, JR., Dix Hills, NY (US)

Correspondence Address: MOTOROLA, INC., 1303 EAST ALGONQUIN ROAD, IL01/3RD, SCHAUMBURG, IL, 60196, US

(73) Assignee: Symbol Technologies, Inc., Holtsville, NY (US)

(21) Appl. No.: 11/782,495

(22) Filed: Jul. 24, 2007

(51) Int. Cl. H01Q 1/00

(52) U.S. Cl. 343/878

(57) ABSTRACT

Methods, systems, and apparatuses for radio frequency identification (RFID) readers are described. In as aspect, a reader antenna includes an attaching element, a radome with an attached director element and a radiating element. The radiating element is positioned coupled to a surface of the attaching element. The radiating element transmits a RF signal for the reader antenna. The director element attached to the radome element focuses the RF signal to alter a characteristic of the RF signal transmitted by the reader antenna.

### BACKGROUND OF THE INVENTION

1. Field of the Invention

The present invention relates to wireless communications, and more particularly, to radio frequency identification (RFID) readers that communicate with RFID tags.

2. Background Art

Radio frequency identification (RFID) tags are electronic devices that may be affixed to items whose presence is to be detected and/or monitored. The presence of an RFID tag, and therefore the presence of the item to which the tag is affixed, may be checked and monitored wirelessly by devices known as “readers.” Readers typically have one or more antennas transmitting radio frequency signals to which tags respond. Since the reader “interrogates” RFID tags, and receives signals back from the tags in response to the interrogation, the reader is sometimes termed as “reader interrogator” or simply “interrogator”.

With the maturation of RFID technology, efficient communications between tags and interrogators has become a key enabler in supply chain management, especially in manufacturing, shipping, and retail industries, as well as in building security installations, healthcare facilities, libraries, airports, warehouses etc.

In a RFID system, typically a reader transmits a continuous wave (CW) or modulated radio frequency (RF) signal to a tag. The tag receives the signal, and responds by modulating the signal, “backscattering” an information signal to the reader. The reader receives signals back from the tag, and the signals are demodulated, decoded and further processed.

What is needed are inexpensive and non-complex ways of increasing transmitted signal ranges for readers. Furthermore, what is needed are ways of increasing range while decreasing an amount of interference between readers operating in the field. Furthermore, what is needed are ways of decreasing an input signal power required by readers.

### BRIEF SUMMARY OF THE INVENTION

Methods, systems, and apparatuses for radio frequency identification (RFID) readers are provided. In aspects of the present invention, a director element is used to change characteristics of a communication signal transmitted by a reader antenna, such as focusing the transmitted signal.

In an aspect, a reader includes a radiating element and a director element. The radiating element transmits a RF signal for the reader. The director element focuses the RF signal to alter a characteristic of the RF signal transmitted by the reader.

In aspects, the director element alters one or more characteristics of the RF signal transmitted by the reader, such as narrowing a transmitted signal pattern, increasing a gain, and/or increasing a range of the RF signal transmitted by the reader.

In an aspect, the director element is formed of an electrically conducting material. In alternate embodiments, the director element may be formed of a material that has a high dielectric constant.

In an aspect, the radiating element is attached to an attaching element. Furthermore, in an aspect, the attaching element is configured to absorb and re-radiate the RF signal transmitted by the radiating element to further alter and/or improve the RF signal. In a further aspect, the attaching element is configured to be retrofitted to existing readers.

These and other objects, advantages and features will become readily apparent in view of the following detailed description of the invention. Note that the Summary and Abstract sections may set forth one or more, but not all exemplary embodiments of the present invention as contemplated by the inventor(s).

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 shows an environment where RFID readers communicate with an exemplary population of RFID tags.

FIG. 2 shows a block diagram of receiver and transmitter portions of an RFID reader.

FIGS. 3 and 4 show front and cross-sectional side views of an example reader antenna.

FIG. 5 shows a mounting bracket coupled to the reader antenna of FIG. 4, according to an example embodiment.

FIGS. 6 and 7A show cross-sectional side and back views of a radome element, according to an example embodiment of the present invention.

FIG. 7B shows a view of another example radome element, according to an example embodiment of the present invention

FIGS. 8 and 9 show cross-sectional side and back views of a reader antenna, according to an example embodiment of the present invention.

FIG. 10 shows a flowchart providing example steps for operation of the reader of FIGS. 8 and 9, according to an example embodiment of the present invention.

FIGS. 11-13 show example steps that may be performed during the flowchart of FIG. 10, according to embodiments of the present invention.

FIG. 14 shows example radiated signal patterns for readers, according to embodiments of the present invention

The present invention will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION OF THE INVENTION

### Introduction

The present specification discloses one or more embodiments that incorporate the features of the invention. The disclosed embodiment(s) merely exemplify the invention. The scope of the invention is not limited to the disclosed embodiment(s). The invention is defined by the claims appended hereto.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Furthermore, it should be understood that spatial descriptions (e.g., “above,” “below,” “up,” “left,” “right,” “down,” “top,” “bottom,” “vertical,” “horizontal,” etc.) used herein are for purposes of illustration only, and that practical implementations of the structures described herein can be spatially arranged in any orientation or manner. Likewise, particular bit values of “0” or “1” (and representative voltage values) are used in illustrative examples provided herein to represent data for purposes of illustration only. Data described herein can be represented by either bit value (and by alternative voltage values), and embodiments described herein can be configured to operate on either bit value (and any representative voltage value), as would be understood by persons skilled in the relevant art(s).

### Example RFID System Embodiment

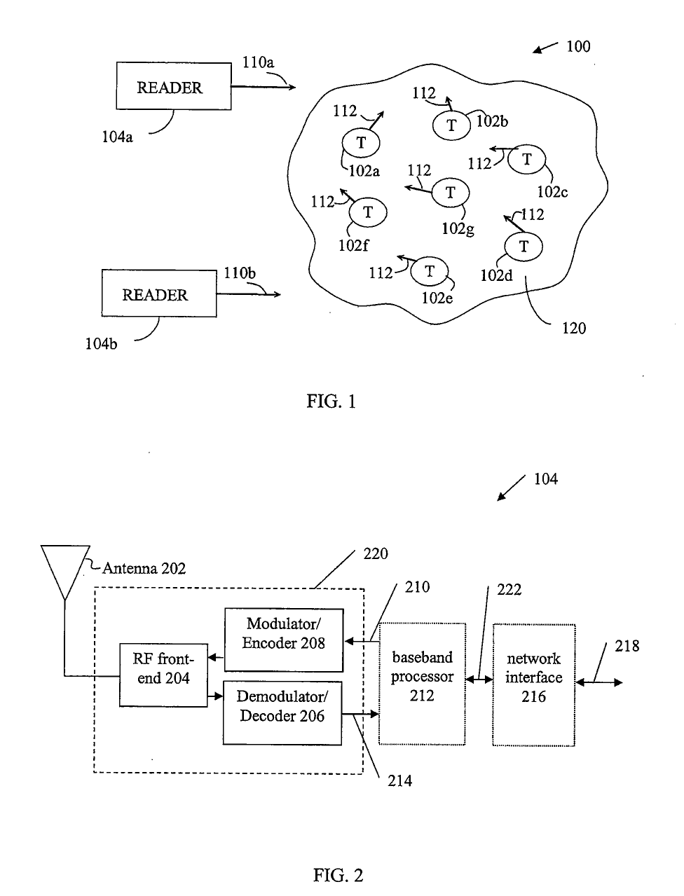

Before describing embodiments of the present invention in detail, it is helpful to describe an example RFID communications environment in which the invention may be implemented. FIG. 1 illustrates an environment 100 where RFID tag readers 104 communicate with an exemplary population 120 of RFID tags 102. As shown in FIG. 1, the population 120 of tags includes seven tags 102a-102g. A population 120 may include any number of tags 102.

Environment 100 includes any number of one or more readers 104. For example, environment 100 includes a first reader 104a and a second reader 104b. Readers 104a and/or 104b may be requested by an external application to address the population of tags 120. Alternatively, reader 104a and/or reader 104b may have internal logic that initiates communication, or may have a trigger mechanism that an operator of a reader 104 uses to initiate communication. Readers 104a and 104b may also communicate with each other in a reader network.

As shown in FIG. 1, reader 104a transmits an interrogation signal 110 having a carrier frequency to the population of tags 120. Reader 104b transmits an interrogation signal 110b having a carrier frequency to the population of tags 120. Readers 104a and 104b typically operate in one or more of the frequency bands allotted for this type of RF communication. For example, frequency bands of 902-928 MHz and 2400-2483.5 MHz have been defined for certain RFID applications by the Federal Communication Commission (FCC).

Various types of tags 102 may be present in tag population 120 that transmit one or more response signals 112 to an interrogating reader 104, including by alternatively reflecting and absorbing portions of signal 110 according to a time-based pattern or frequency, and/or a phase shift in the reflected signal according to a time-based pattern or frequency. This technique for alternatively absorbing and reflecting signal 110 is referred to herein as backscatter modulation in amplitude or phase. Readers 104a and 104b receive and obtain data from response signals 112, such as an identification number of the responding tag 102. In the embodiments described herein, a reader may be capable of communicating with tags 102 according to any suitable communication protocol, including Class 0, Class 1, EPC Gen 2, other binary traversal protocols and slotted aloha protocols, any other protocols mentioned elsewhere herein, and future communication protocols.

FIG. 2 shows a block diagram of an example RFID reader 104. Reader 104 includes one or more antennas 202, a receiver and transmitter portion 220 (also referred to as transceiver 220), a baseband processor 212, and a network interface 216. These components of reader 104 may include software, hardware, and/or firmware, or any combination thereof, for performing their functions.

Baseband processor 212 and network interface 216 are optionally present in reader 104. Baseband processor 212 may be present in reader 104, or may be located remote from reader 104. For example, in an embodiment, network interface 216 may be present in reader 104, to communicate between transceiver portion 220 and a remote server that includes baseband processor 212. When baseband processor 212 is present in reader 104, network interface 216 may be optionally present to communicate between baseband processor 212 and a remote server. In another embodiment, network interface 216 is not present in reader 104.

In an embodiment, reader 104 includes network interface 216 to interface reader 104 with a communications network 218. As shown in FIG. 2, baseband processor 212 and network interface 216 communicate with each other via a communication link 222. Network interface 216 is used to provide an interrogation request 210 to transceiver portion 220 (optionally through baseband processor 212), which may be received from a remote server coupled to communications network 218. Baseband processor 212 optionally processes the data of interrogation request 210 prior to being sent to transceiver portion 220. Transceiver 220 transmits the interrogation request via antenna 202.

Reader 104 has at least one antenna 202 for communicating with tags 102 and/or other readers 104. Antenna(s) 202 may be any type of reader antenna known to persons skilled in the relevant art(s), including a vertical, dipole, loop, Yagi-Uda, slot, or patch (sometimes referred to as a micro strip or printed circuit) antenna type. For description of an example antenna suitable for reader 104, refer to U.S. Ser. No. 11/265,143, filed Nov. 3, 2005, titled “Low Return Loss Rugged RFID Antenna,” now pending, which is incorporated by reference herein in its entirety.

Transceiver 220 receives a tag response via antenna 202. Transceiver 220 outputs a decoded data signal 214 generated from the tag response. Network interface 216 is used to transmit decoded data signal 214 received from transceiver portion 220 (optionally through baseband processor 212) to a remote server coupled to communications network 218. Baseband processor 212 optionally processes the data of decoded data signal 214 prior to being sent over communications network 218.

In embodiments, network interface 216 enables a wired and/or wireless connection with communications network 218. For example, network interface 216 may enable a wireless local area network (WLAN) link (including an IEEE 802.11 WLAN standard link), a BLUETOOTH link, and/or other types of wireless communication links. Communications network 218 may be a local area network (LAN), a wide area network (WAN) (e.g., the Internet), and/or a personal area network (PAN).

In embodiments, a variety of mechanisms may be used to initiate an interrogation request by reader 104. For example, an interrogation request may be initiated by a remote computer system/server that communicates with reader 104 over communications network 218. Alternatively, reader 104 may include a finger-trigger mechanism, a keyboard, a graphical user interface (GUI), and/or a voice activated mechanism with which a user of reader 104 may interact to initiate an interrogation by reader 104.

In the example of FIG. 2, transceiver portion 220 includes a RF front-end 204, a demodulator/decoder 206, and a modulator/encoder 208. These components of transceiver 220 may include software, hardware, and/or firmware, or any combination thereof, for performing their functions. Example description of these components is provided as follows.

Modulator/encoder 208 receives interrogation request 210, and is coupled to an input of RF front-end 204. Modulator/encoder 208 encodes interrogation request 210 into a signal format, modulates the encoded signal, and outputs the modulated encoded interrogation signal to RF front-end 204. For example, pulse-interval encoding (PIE) may be used in a Gen 2 embodiment. Furthermore, double sideband amplitude shift keying (DSB-ASK), single sideband amplitude shift keying (SSB-ASK), or phase-reversal amplitude shift keying (PR-ASK) modulation schemes may be used in a Gen 2 embodiment. Note that in an embodiment, baseband processor 212 may alternatively perform the encoding function of modulator/encoder 208.

RF front-end 204 may include one or more antenna matching elements, amplifiers, filters, an echo-cancellation unit, a down-converter, and/or an up-converter. RF front-end 204 receives a modulated encoded interrogation signal from modulator/encoder 208, up-converts (if necessary) the interrogation signal, and transmits the interrogation signal to antenna 202 to be radiated. Furthermore, RF front-end 204 receives a tag response signal through antenna 202 and down-converts (if necessary) the response signal to a frequency range amenable to further signal processing.

Demodulator/decoder 206 is coupled to an output of RF front-end 204, receiving a modulated tag response signal from RF front-end 204. In an EPC Gen 2 protocol environment, for example, the received modulated tag response signal may have been modulated according to amplitude shift keying (ASK), phase shift keying (PSK), or a combination of the modulation techniques. Demodulator/decoder 206 demodulates the tag response signal. For example, the tag response signal may include backscattered data formatted according to FMO or Miller encoding formats in an EPC Gen 2 embodiment. Demodulator/decoder 206 outputs decoded data signal 214. Note that in an embodiment, baseband processor 212 may alternatively perform the decoding function of demodulator/decoder 206.

Example embodiments of the present invention are described in further detail below. Such embodiments may be implemented in the environments and readers described above, and/or in alternative environments and alternative RFID devices.

### Example Embodiments for Radiating Elements

Methods, systems, and apparatuses for improved reader antennas are described. In an embodiment, a radiating element of a reader antenna is mounted in a reflecting element. The reflecting element causes the reader antenna to radiate a modified RF signal. The modified RF signal may have various improved attributes, including beam shape, gain, and/or range. These embodiments can be implemented in many types of RFID readers, including those described above and otherwise known.

The example embodiments described herein are provided for illustrative purposes, and are not limiting. The examples described herein may be adapted to any type of tag and reader. Further structural and operational embodiments, including modifications/alterations, will become apparent to persons skilled in the relevant art(s) from the teachings herein.

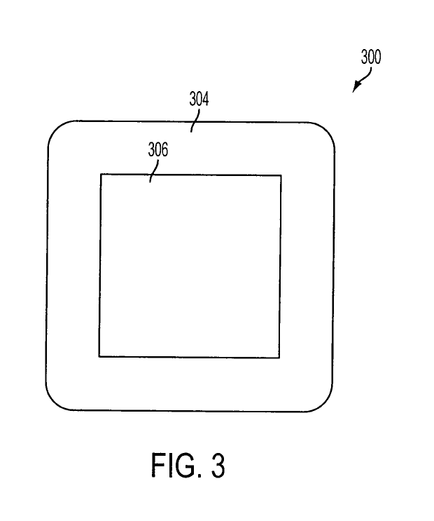

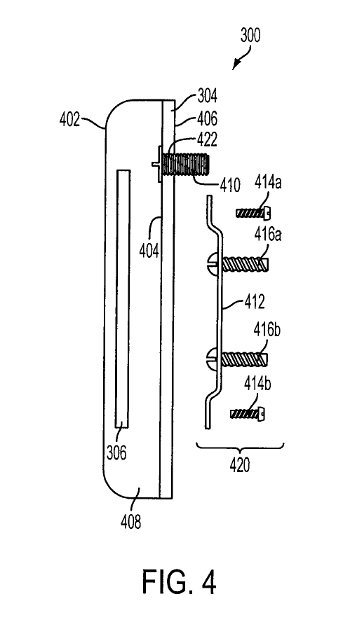

FIG. 3 shows a front view of a reader antenna 300, according to an example embodiment of the present invention. FIG. 4 shows a cross-sectional side view of reader antenna 300. Reader antenna 300 may be an antenna similar to those described above, a reader antenna as described in U.S. Ser. No. 11/265,143, filed Nov. 3, 2005, titled “Low Return Loss Rugged RFID Antenna,” or a reader antenna otherwise known. As shown in FIG. 3, reader antenna 300 has a substantially rectangular shape, with rounded corners. However, in alternative embodiments, reader antenna 300 may have other shapes, including round or elliptical, elongated, etc.

In FIG. 3, a counterpoise element 304 and a radiating element 306 of reader antenna 300 are shown. FIG. 4 shows reader antenna 300 including counterpoise element 304, radiating element 306, and a radome 402 (radome 402 is not shown in FIG. 3).

As shown in FIG. 4, counterpoise element 304 is planar in shape, and has opposing first and second surfaces 404 and 406. Radome 402 is cup-shaped, and is mounted to first surface 404 of counterpoise element 304 to form an enclosure 408. Radiating element 306 is shown in FIGS. 3 and 4 as a patch-type radiator/antenna. Radiating element 306 can also be referred to as an antenna, a patch antenna, a radiator, a patch radiator, etc. However, in alternative embodiments, radiating element 306 may be a type of radiator/antenna other than a patch radiator. As shown in FIG. 4, radiating element 306 is positioned in enclosure 408.

Radiating element 306 can be made of any suitable material, including a metal. Counterpoise element 304 can be made of any suitable material, including a metal. Furthermore, in an embodiment, counterpoise element 304 may be coupled to a ground (or other) electrical potential to operate as a ground plane for reader antenna 300. Radome 402 is configured to protect radiating element 306 from impacts, etc. Radome 402 can be made of any suitable material, including a plastic, polymer, etc.

FIG. 4 further shows a RF input signal connector 410. RF input signal connector 410 mounts in a port 422 through counterpoise element 304. An RF input signal is received on RF input signal connector 410, and is coupled to radiating element 306, which radiates the RF input signal. The coupling of RF input signal connector 410 to radiating element 306 is not shown in FIG. 4, but may be accomplished in a variety of ways, as would be known to persons skilled in the relevant art(s), such as by a wire other electrical connection. The RF input signal may be an interrogation signal, such as interrogation signal 110a shown in FIG. 1, or other signal radiated from an antenna of a reader.

FIG. 4 further shows a mounting bracket 412, a first set of attachment members 414a and 414b, and a second set of attachment member 416a and 416b, which form an interface mechanism 420 that can be used to mount reader antenna 300 to a surface/object. First and second sets of attachment members 414 and 416 are shown in FIG. 4 as screws/bolts, but can be any type of attachment mechanism, including nails, screws, bolts, rivets, an adhesive, and/or other mechanism, and can include any number of members.

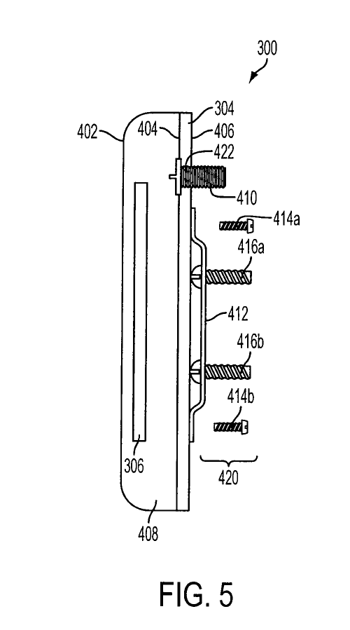

FIG. 5 shows mounting bracket 412 coupled to reader antenna 300, according to an example embodiment. In the example of FIG. 5, attachment members 414, shown as screws, are screwed through mounting bracket 412 into counterpoise element 304 to mount mounting bracket 412 to reader antenna 300. Attachment members 416, also shown as screws, are screwed through a central portion of mounting bracket 412 in a direction opposite to attachment members 414. The ends of attachment members 416 may be further screwed into a surface/object to which reader antenna 300 is to be mounted.

Note that reader antenna 300 can be configured to radiate linear, elliptical, and other signal polarizations, at various power levels. In an embodiment, to conform to current FCC requirements, reader antenna 300 may be configured to transmit to a gain limit of 6 dBi linearly polarized (“linear”), or a 9 dBi circularly polarized (“circular”) equivalent.

### Example Embodiments for Directing Elements

Methods, systems, and apparatuses for improved reader antennas are described. In an embodiment, a directing element is mounted on a radiating element of a reader antenna. The director element causes the reader antenna to radiate a modified RF signal. The modified RF signal may have various improved attributes, including beam shape, gain, polarization characteristics, and/or range. These embodiments can be implemented in many types of RFID readers, including those described above and otherwise known.

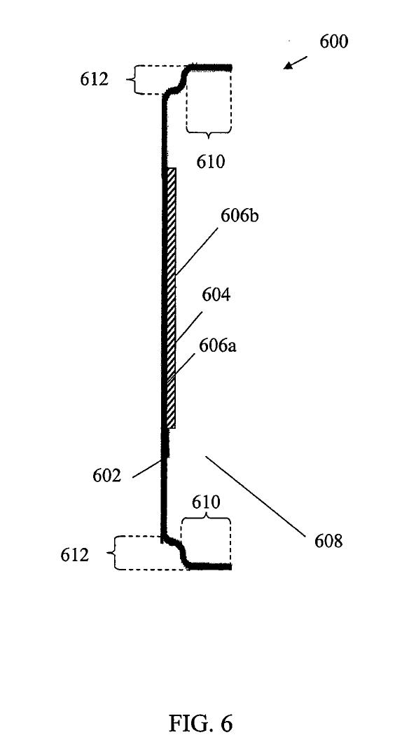

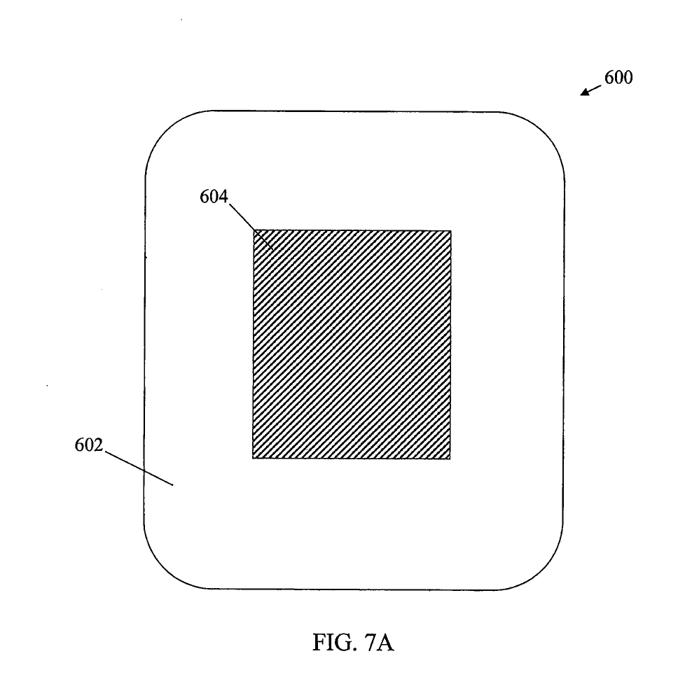

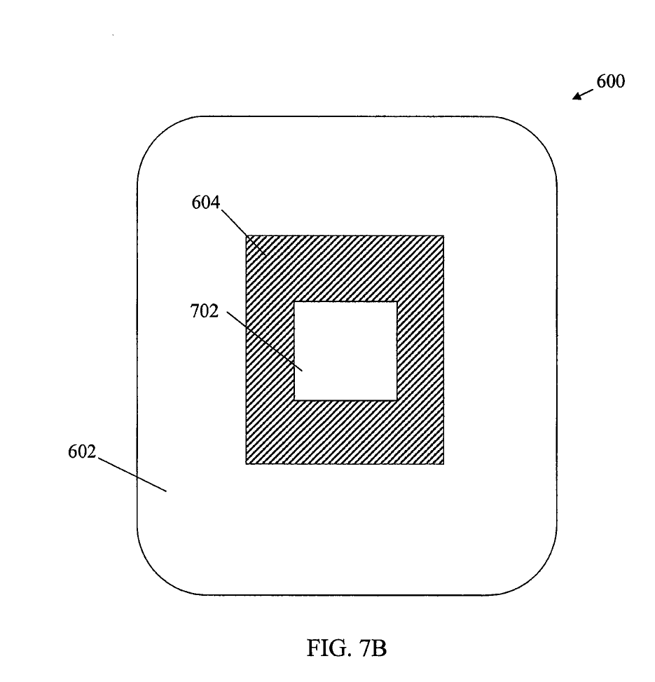

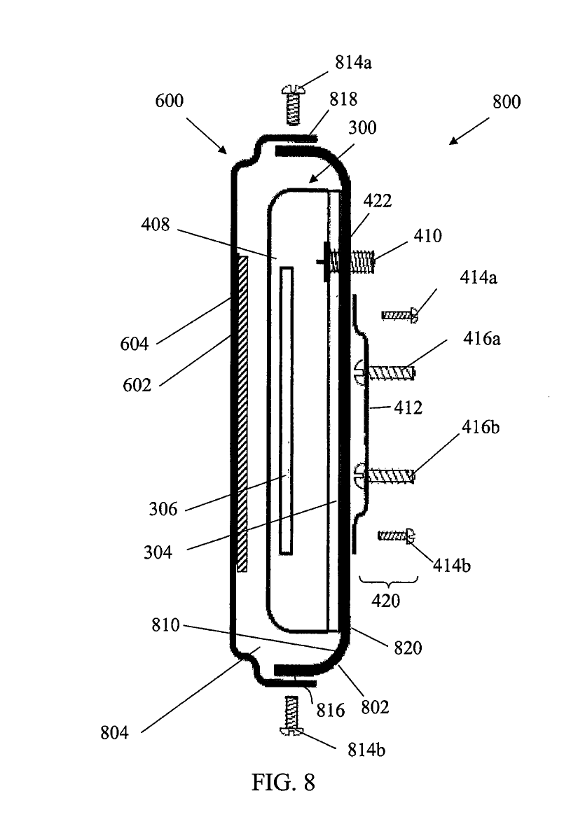

FIGS. 6 and 7A show side cross-sectional and back views respectively of radome 600 according to an embodiment of the present invention. As shown in FIG. 6, radome 600 includes a body 602 and a director element 604. Body 602 is substantially cup-shaped, defining a cavity 608. Body 602 also has a step shape 612 in an outer region that forms a receptacle 610. In embodiments, receptacle 610 enhances mechanical coupling with a radome assembly, e.g. see FIG. 8. Step shape 612 is optional. In alternate embodiments, body 602 may have other shapes such as cone-shaped, planar, etc.

As shown in FIG. 7A, body 602 is substantially rectangular when viewed from the front or back with rounded corners. However, in alternate embodiments, body 602 could be a variety of other shapes including round or elliptical. In embodiments, body 602 is made up of materials transparent to RF electromagnetic waves such as plastics, polymers, etc.

Body 602 serves as a support structure for a director element 604. Director element 604 is attached to a center portion of body 602. Director element 604 has a first surface 606a and second surface 606b. As shown in FIG. 6, a distance between first surface 606a and second surface 606b is uniform. In alternate embodiments, the distance may vary throughout director element 604. FIG. 7A shows director element 604 as being substantially rectangular in shape when viewed from the back. In alternate embodiments, director element 604 may be other shapes such as elliptical, circular, triangular, etc.

Director element 604 may also include an opening 702 in a central portion of director element 604, such as shown in FIG. 7B. In such an embodiment, radome body 602 may or may not cover opening 702. Moreover, director element 604 may also include a plurality of diffraction gratings, Frequency Selective Surface elements, and Meta materials.

Director element 604 may be fabricated from one or more layers. Each of these layers may be a planar sheet, any of the shapes mentioned above, or any other shape as would be understood by someone skilled in the relevant art(s).

Director element 604 may be attached to body 602 in a variety of ways including bolting, molding an adhesive, and riveting. In an embodiment, director element 604 is at least partially made up of an electrically conductive material such as copper. In an alternate embodiment, the director element may be formed of a material that has a high dielectric constant. Director element 604 focuses incoming RF signals (e.g. from the left in FIG. 6, when the antenna is receiving). When attached to a reader assembly, as shown in FIG. 8, director element 604 acts to increase a directivity of the reader assembly.

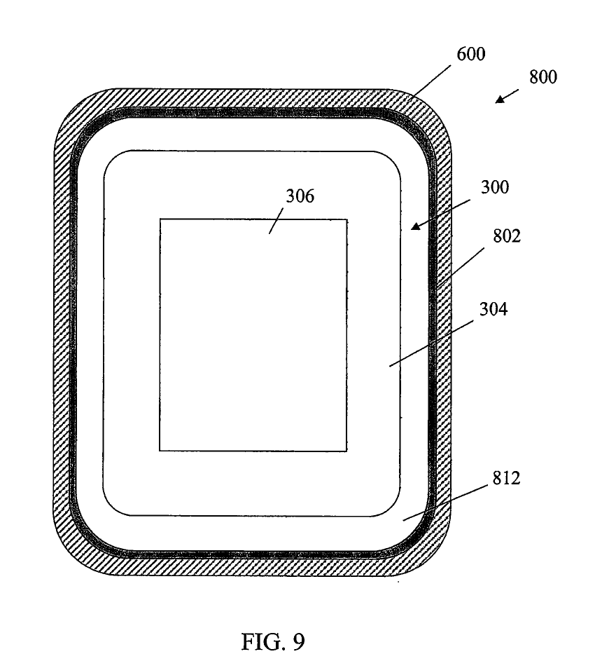

FIGS. 8 and 9 respectively show side cross-sectional and front cross-sectional views of a RFID reader assembly 800 according to an embodiment of the present invention. As shown in FIG. 8, reader assembly 800 includes reader antenna 300, an attaching element 802, and radome 600. Attaching element 802 enables coupling of radome 600 to reader antenna 300. Furthermore, in an embodiment, attaching element 802 may be used as an additional radiating element. For example, attaching element 802 may be configured to absorb and re-radiate the RF signal. In such an embodiment, attaching element 802 focuses RF electromagnetic waves radiated by radiating element 306. For example, attaching element 802 may be a cup shaped reflector as described in pending U.S. application Ser. No. 11/730,865 “RFID Antenna Cupped Reflector,” which is incorporated herein by reference in its entirety. Moreover, when attaching element 802 serves as an additional radiating element, it may be made up of an electrically conductive material such as copper or aluminum. In alternate embodiments, however, attaching element 802 could also be made up of a material transparent to RF electromagnetic waves such as fiber glass, a polymer, a ceramic, or a plastic.

As shown in FIG. 8, attaching element 802 has a cup-shape that defines a cavity. In an embodiment, a portion of an outside surface of a rim 816 of attaching element 802 is coupled to a portion of an inside surface of a rim 818 of body 602 forming an enclosure 804, as shown in FIG. 8. As shown in FIGS. 8 and 9, reader antenna 300 and radiating element 306, are positioned in enclosure 804. Reader antenna 300 is coupled to attaching element 802.

In alternate embodiments, however, attaching element 802 also may be other shapes such as cone-shaped, planar, etc. as would be understood by someone skilled in the relevant art(s).

In an embodiment, radome 600 protects reader antenna 300 from outside elements such as rain and snow. Coupling radome 600 to attaching element 802 positions director element 604 parallel to radiating element 306. During operation, radiating element 306 transmits an RF signal. Director element 604 delays an RF electromagnetic wave front of the transmitted RF signal along a bore sight of radiating element 306 causing a focusing effect along the wave front. In other words, director element 604 is analogous to a lens which focuses the electromagnetic energy that is radiated from radiating element 306. In embodiments, Fresnel, Frequency Selective Surface, and Meta Material principles are used to design the shape of director element 604 to further enhance the focusing properties of director element 604, as would be understood by someone skilled in the relevant arts(s).

FIG. 8 further shows a third set of attachment members 814a and 814b, in addition to first set of attachment members 414a and 414b and second set of attachment members 416a and 416b, that can be used to couple radome 600 to attaching element 802. Attachment members 814a and 814b are shown in FIG. 8 as screws/bolts, but can be any type of attachment mechanism, including nails, screws, bolts, rivets, an adhesive, and/or other mechanism, and can include any number of members.

In the example of FIG. 8, attachment members 814, shown as screws, are screwed through body 602 of radome 600 into attaching element 802. After attaching body 602 to attaching element 802, enclosure 804 is formed.

In the example of FIG. 8, reader antenna 300 is mounted in enclosure 804 to attaching element 802 which is coupled to radome 600 to form reader assembly 800. In particular, second surface 422 of counterpoise element 304 is coupled to a planar portion of an inner surface 810 of attaching element 802, in enclosure 804. RF input signal connector 410 is positioned in a port through attaching element 802 and in port 422 in counterpoise element 304 to extend into enclosure 408 for coupling to radiating element 306.

Reader assembly 800 may be mounted to surfaces/objects using a variety of mounting configurations, including standard mounting structures. For example, interface mechanism 420 for reader antenna 300 may be adapted to mount reader assembly 800. As shown in FIG. 9, mounting bracket 412 is coupled an outer surface 820 of attaching element 802, external to enclosure 804. In the example of FIG. 8, attachment members 414, shown as screws, are screwed first through mounting bracket 412, next through attaching element 804, and finally into counterpoise element 304. In this manner, attachment members 414 fasten mounting bracket 412 to reader assembly 800, and attachment members 416 can be used to fasten reader assembly 800 to a surface/object via mounting bracket 412. Note that other mounting mechanisms may be used to mount reader assembly 800, as would be known to persons skilled in the relevant art(s).

Reader assembly 800 includes reader antenna 300. As shown in FIG. 8, reader antenna 300 includes radome 402. In alternate embodiments, however, reader assembly 800 may not include radome 402.

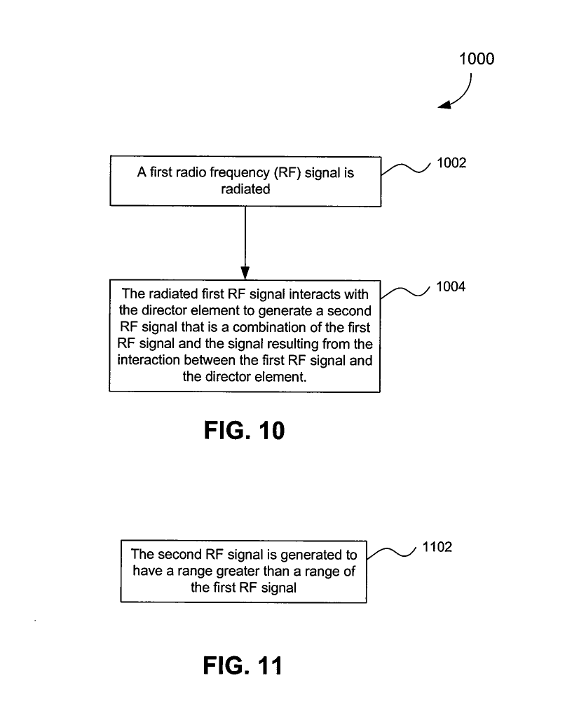

FIG. 10 shows a flowchart 1000 providing example steps for operation of a reader such as reader assembly 800, according to an example embodiment of the present invention. Other structural and operational embodiments will be apparent to persons skilled in the relevant art(s) based on the following discussion. The steps of flowchart 1000 are described in detail below.

Flowchart 1000 begins with step 1002. In step 1002, a first radio frequency (RF) signal is radiated. For example, in an embodiment, radiating element 306 transmits a RF signal to tags, such as a signal to power the tags and/or an interrogation signal (such as interrogation signal 110a of FIG. 1). The RF signal is generally radiated in a direction perpendicular to radiating element 306 along the bore sight of radiating element 306. In the example of FIG. 5 for reader antenna 300, the RF signal is radiated generally in a leftward direction from radiating element 306 (due to the presence of counterpoise element 304).

In step 1004, the radiated first RF signal interacts with director element 604 to generate a second RF signal that is a combination of the first RF signal and the signal resulting from the interaction between the first RF signal and the director element. For example, director element may be director element 604 shown in FIGS. 6 and 7. In an embodiment, the RF signal is focused generally in a same direction as the RF signal radiated from radiating element 306.

FIGS. 11-13 show example steps for step 1004 of flowchart 1000, according to an embodiment of the present invention.

FIG. 11 shows a step 1102. In step 1102 of FIG. 11, the second RF signal is generated to have greater range than the first RF signal. Thus, for example, in an embodiment, the RF signal radiated from the combination of radiating element 306 and director element 604 has a range which is larger than a range of a similar input power level signal radiated by radiating element 306 alone.

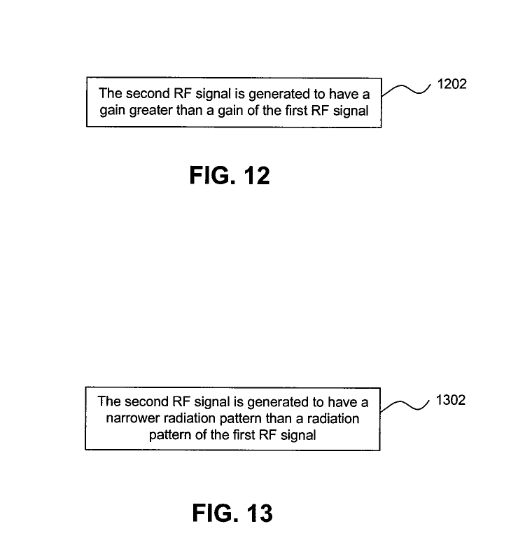

FIG. 12 shows a step 1202. In step 1202 of FIG. 12, the second RF signal is generated to have a gain greater than a gain of the first RF signal. Thus, for example, in an embodiment, the RF signal radiated from the combination of radiating element 306 and director element 604 has a gain greater than a gain of a similar input power level signal radiated by radiating element 306 alone.

FIG. 13 shows a step 1302. In step 1302 of FIG. 13, the second RF signal is generated to have a narrower radiation pattern than a radiation pattern of the first RF signal. Thus, for example, in an embodiment, the RF signal radiated from the combination of radiating element 306 and director element has a narrower pattern than a pattern of a similar power level signal radiated by radiating element 306 alone.

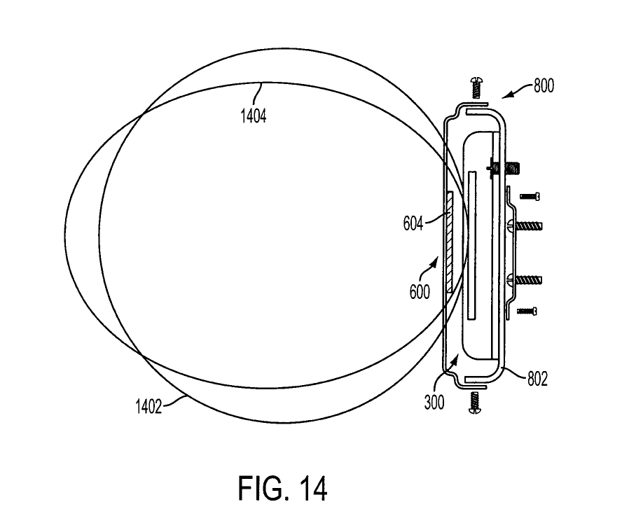

FIG. 14 shows an of example radiated signal patterns for reader antenna 300 of FIG. 5 and reader assembly 800 of FIG. 8. FIG. 14 shows a first radiated signal pattern 1402 for reader antenna 300 (no additional radome) and a second radiated signal pattern 1404 for reader assembly 800 (having radome 600 with director element 604 and attaching element 802) (reader assembly 800 is shown in FIG. 14 for illustrative purposes, to show a reader position relative to the signal patterns). The radius of the signal patterns versus angle of FIG. 14 represent the spatial directions where the reader antenna develops various gains. As shown in FIG. 14, second radiated signal pattern 1404 for reader assembly 800 has a higher gain and range, and is narrower (from top to bottom in FIG. 14), relative to first radiated signal pattern 1402 for reader antenna 300. For example, first radiated signal pattern 1402 may have a bore sight gain of 6 dBi linear (9 dBi circular equivalent), while second radiated signal pattern 1404 has a bore sight gain of 8.2 dBi linear (11.2 dBi circular equivalent). Thus, the addition of a radome with an attached director element can be used to increase gain, range, and create a narrower, more focused, signal pattern for a reader antenna.

### Example Computer System Embodiments

In this document, the terms “computer program medium” and “computer usable medium” are used to generally refer to media such as a removable storage unit, a hard disk installed in hard disk drive, and signals (i.e., electronic, electromagnetic, optical, or other types of signals capable of being received by a communications interface). These computer program products are means for providing software to a computer system. The invention, in an embodiment, is directed to such computer program products.

In an embodiment where aspects of the present invention are implemented using software, the software may be stored in a computer program product and loaded into a computer system using a removable storage drive, hard drive, or communications interface. The control logic (software), when executed by a processor, causes the processor to perform the functions of the invention as described herein.

According to an example embodiment, an RFID reader may execute computer-readable instructions to transmit a RF signal, as further described elsewhere herein.

Conclusion

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

1. A radio frequency identification (RFID) reader antenna, comprising:
a patch radiating element;
a counterpoise element having opposing first and second surfaces;
a radome having opposing first and second surfaces, wherein the radome is substantially cup-shaped, wherein the radome comprises a material transparent to RF electromagnetic waves; and
a director element attached to a center portion of a surface of the radome.

2. The RFID reader antenna of claim 1, further comprising:
an attaching element having opposing first and second surfaces, wherein the attaching element defines a cavity, wherein the counterpoise element is coupled to the first surface of the attaching element, wherein a second surface of the attaching element is coupled to the first surface of the radome such that an enclosure is formed, wherein the radiating element and the counterpoise element are positioned within the enclosure.

3. The RFID reader antenna of claim 2, further comprising:
a radio frequency (RF) input signal connector;
wherein said counterpoise element has a port that receives RF input signal connector; and
wherein a RF input signal from the RF input signal connector is coupled to the patch radiating element.

4. The RFID reader antenna of claim 3, further comprising:
a mounting bracket coupled to a second surface of the body external to the cavity.

5. The RFID reader antenna of claim 4, further comprising:
a first plurality of attachment members that fasten the mounting bracket to the second surface of the body.

6. The RFID reader antenna of claim 5, further comprising:
a second plurality of attachment members coupled to the mounting bracket;
wherein the second plurality of attachment members are configured to mount the RFID reader antenna to an operating location.

7. The RFID reader antenna of claim 2, wherein the attaching element is at least partially formed of a conductive material.

8. The RFID reader antenna of claim 2, wherein the attaching element focuses RF electromagnetic waves radiated from the radiating element.

9. The RFID reader antenna of claim 1, wherein the director element is at least partially formed of a conductive material.

10. The RFID reader antenna of claim 1, wherein the radome has a substantially rectangular shape.

11. The RFID reader antenna of claim 10, wherein the radome has at least one rounded corner.

12. The RFID reader antenna of claim 1, wherein the director element focuses electromagnetic waves radiated by the radiating element.

13. The RFID reader antenna of claim 1, wherein the director element is bolted to the center portion of the first surface of the first radome.

14. The RFID reader antenna of claim 1, wherein the director element is molded to the center portion of the first surface of the first radome.

15. The RFID reader antenna of claim 1, wherein the director element is riveted to the center portion of the first surface of the first radome.

16. The RFID reader antenna of claim 1, wherein the director element is clipped into the to the center portion of the first surface of the first radome.

17. The RFID reader antenna of claim 1, wherein the director element has a substantially rectangular shape.

18. The RFID reader antenna of claim 1, wherein the director element has an elliptical shape.

19. The RFID reader antenna of claim 1, wherein the director element has a substantially triangular shape.

20. The RFID reader antenna of claim 1, wherein the director element comprises a diffraction grating.

21. The RFID reader antenna of claim 1, wherein the director element is comprised of a planar region of conducting material.

22. The RFID reader antenna of claim 21, wherein the planar region of conducting material has a central opening.

23. The RFID reader antenna of claim 1, wherein the director element is comprised of one or more layers.

24. The RFID reader antenna of claim 1, wherein the radome is configured to increase a radiating range of the RFID reader antenna relative to a radiating range of the patch radiating element.

25. The RFID reader antenna of claim 1, wherein the radome is configured to increase a gain of the RFID reader antenna relative to a gain of the patch radiating element.

26. The RFID reader antenna of claim 1, wherein the radome is configured to narrow a width of a pattern radiated by the RFID reader antenna relative to a pattern radiated by the patch radiating element.

27. The RFID reader antenna of claim 1, wherein the director element is configured to enhance a structural integrity of the radome.

28. The RFID reader antenna of claim 1, wherein the director element is comprised of a non-planar region of conductive material.

29. The RFID reader antenna of claim 1, wherein the shape of the director element is configured according to Fresnel principles.

30. A method in a radio frequency identification (RFID) reader antenna, comprising:
radiating a first radio frequency (RF) signal; and
focusing the radiated first RF signal with a director element attached to a radome to generate a second RF signal that is a combination of the first RF signal and the focused first signal.

31. The method of claim 30, wherein said radiating comprises:
radiating the first radio frequency (RF) signal from a patch radiating element.

32. The method of claim 31, wherein said radiating further comprises:
re-radiating the first radio frequency (RF) signal from the director element attached to the radome.

33. The method of claim 32, wherein said re-radiating comprises:
generating the second RF signal to have a range greater than a range of the first RF signal.

34. The method of claim 32, wherein said re-radiating comprises:
generating the second RF signal to have a gain greater than a gain of the first RF signal.

35. The method of claim 32, wherein said re-radiating comprises:
generating the second RF signal to have a narrower radiation pattern than a radiation pattern of the first RF signal.

36. A radio frequency identification (RFID) reader antenna, comprising:
means for radiating a first radio frequency (RF) signal; and
means for focusing the radiated first RF signal to generate a second RF signal that is a combination of the first RF signal and the focused RF signal.

37. A radome comprising:
a substantially cup-shaped body, wherein the body is comprised of a material that is transparent to RF electromagnetic waves, wherein the body is configured to attach to a concave reflecting body; and
a director element attached to a center portion of a first surface of the body.
